(19) United States
(12) Patent Application Publication
(10) Pub. No.: US 2014/0335246 A1
(43) Pub. Date: Nov. 13, 2014

(54) SWEETENER COMPOSITIONS AND METHODS OF MAKING SAME

(71) Applicants: Luke Zhang, Vancouver (CA); Kevin Li, Vancouver (CA)

(72) Inventors: Luke Zhang, Vancouver (CA); Kevin Li, Vancouver (CA)

(73) Assignee: GLG LIFE TECH CORPORATION, Vancouver, BC (CA)

(21) Appl. No.: 13/810,372

(22) PCT Filed: Jul. 15, 2011
(86) PCT No.: PCT/CA11/00824

§ 371 Date: Jun. 12, 2014

Related U.S. Application Data
(60) Provisional application No. 61/364,782, filed on Jul. 15, 2010.

(51) Int. Cl. A23L 1/09; A23L 2/60

(52) U.S. Cl. CPC A23L 1/09; A23L 2/60; A23V 2002/00
USPC 426/271; 426/658; 426/548; 426/442; 426/590

(57) ABSTRACT

A natural sweetener composition comprises a blend of Stevioside extract and Rebaudioside A extract, wherein the ratio of Rebaudioside A extract to Stevioside extract is between about 12:1 to about 1:12 and the purity of both extracts is from about 60% to about 97.5%. The sweetener composition may further include sweet sugars and non-natural sugars.

### FIELD OF THE INVENTION

The present invention relates generally to natural sweetener compositions comprising plant extracts methods for producing the same.

### BACKGROUND

In the food and beverage industry, there is a general preference for the consumption of sweet foods, and manufacturers and consumers commonly add sugar in the form of sucrose (table sugar), fructose or glucose to beverages, food, etc. to increase the sweet quality of the beverage or food item. Although most consumers enjoy the taste of sugar, sucrose, fructose and glucose are high calorie sweeteners. Many alternatives to these high calorie sweeteners are artificial sweeteners or sugar substitutes, which can be added as an ingredient in various food items.

Common artificial sweeteners include saccharin, aspartame, and sucralose. Unfortunately, these artificial sweeteners have been associated with negative side effects. Therefore, alternative, natural non-caloric or low-caloric or reduced caloric sweeteners have been receiving increasing demand as alternatives to the artificial sweeteners and the high calorie sweeteners comprising sucrose, fructose and glucose. Like some of the artificial sweeteners, these alternatives provide a greater sweetening effect than comparable amounts of caloric sweeteners; thus, smaller amounts of these alternatives are required to achieve a sweetness comparable to that of sugar. These alternative, natural sweeteners, however, can be expensive to produce and/or possess taste characteristics different than sugar (such as sucrose), including, in some instances, undesirable taste characteristics such as sweetness linger, delayed sweetness onset, negative mouth feels and different taste profiles, such as off-tastes, including bitter, metallic, cooling, astringent, licorice-like tastes.

It is an object of the present invention to obviate or mitigate the above disadvantages.

### SUMMARY OF THE INVENTION

The present invention provides natural sweetener compositions comprising sweet steviol glycosides, methods for producing the same and uses thereof.

The present invention further provides a natural sweetener composition comprising a blend of Stevioside (STV) extract and Rebaudioside A extract.

The present invention further provides a natural sweetener composition comprising a blend of Stevioside extract and Rebaudioside A extract wherein the ratio of Rebaudioside A extract to Stevioside extract is between about 12:1 to about 1:12. The present invention further provides a natural sweetener composition comprising a blend of Stevioside extract and Rebaudioside A extract wherein the ratio of Rebaudioside A to Stevioside is from about 12:1 to about 2:1. According to these aspects, the Rebaudioside A extract and the Stevioside extract may (each or both) have a purity between about 60% to about 97.5% purity.

In another aspect of the present invention, a natural sweetener composition comprising a blend of Stevioside extract and Rebaudioside A extract is provided wherein, as an advantage of such a blend, extracts of lower purity can be used, as compared to usage of either extract alone, wherein higher purity is required for commercial applicability and consumer acceptance. According to this aspect, there is provided a natural sweetener composition comprising a Rebaudioside A extract having a purity between about 60% to about 97.5% purity. According to another aspect, there is provided a natural sweetener composition comprising a Stevioside extract having a purity between about 60% to about 97.5% purity.

The present invention further provides a process of extracting Rebaudioside A and Stevioside extracts from source stevia leaves.

The present invention further provides a process of purifying Rebaudioside A from a stevia leaf extract. The present invention further provides a process of purifying Stevioside from a stevia leaf extract.

The present invention further provides natural sweetener compositions comprising sweet steviol glycosides and one or more other natural sugars or sugar substitutes.

The present invention further provides foods, beverages, nutraceuticals, medicinal formulations, cosmetics, health products, condiments and seasonings comprising a blend of Stevioside extract and Rebaudioside A extract.

The natural sweetener compositions of the present invention may be zero calories or merely reduced calorie, as desired.

These and other objects and advantages of the present invention will become more apparent to those skilled in the art upon reviewing the description of the preferred embodiments of the invention, in conjunction with the figures and examples. A person skilled in the art will realize that other embodiments of the invention are possible and that the details of the invention can be modified in a number of respects, all without departing from the inventive concept. Thus, the following drawings, descriptions and examples are to be regarded as illustrative in nature and not restrictive.

### BRIEF DESCRIPTION OF THE DRAWINGS

Embodiments of the present invention will now be described, by way of example only, with reference to the attached Figures, wherein:

FIG. 1 is a flow diagram of the extraction process for extracting a primary extract of steviol glycosides from the leaves of Stevia rebaudiana;

FIG. 2 is a flow diagram of the purification process for purifying Reb A extract from the primary extract of steviol glycosides extracted from the leaves of Stevia rebaudiana; and

FIG. 3 is a flow diagram of the purification process for purifying STV extract from the primary extract of steviol glycosides extracted from the leaves of Stevia rebaudiana.

### DETAILED DESCRIPTION OF THE INVENTION

A detailed description of one or more embodiments of the invention is provided below along with accompanying figures that illustrate the principles of the invention. As such this detailed description illustrates the invention by way of example and not by way of limitation. The description will clearly enable one skilled in the art to make and use the invention, and describes several embodiments, adaptations, variations and alternatives and uses of the invention, including what we presently believe is the best mode for carrying out the invention. It is to be clearly understood that routine variations and adaptations can be made to the invention as described, and such variations and adaptations squarely fall within the spirit and scope of the invention.

In other words, the invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In the present disclosure and claims (if any), the word “comprising” and its derivatives including “comprises” and “comprise” include each of the stated integers or elements but does not exclude the inclusion of one or more further integers or elements.

Natural sweetener compositions that have a taste profile comparable to sugar are desired. Further, a composition that is not prohibitively expensive to produce is preferred. Such a composition can be added, for example, to beverages and food products to satisfy consumers looking for a sweet taste. There is provided herein a sweetener composition comprising Rebaudioside A (Reb A) and Stevioside (STV) extracts wherein the Reb A and STV extracts are extracted from stevia plants. The sweetener composition is a natural, healthy and safe alternative to artificial sweeteners and sucrose-, fructose- and glucose-based sweeteners. Furthermore, the sweetener composition has a good overall taste, has little or no associated bitterness and provides a calorie free or reduced calorie sweetener.

The genus Stevia consists of about 240 species of plants native to South America, Central America, and Mexico, with several species found as far north as Arizona, New Mexico, and Texas. They were first researched by Spanish botanist and physician Petrus Jacobus Stevus (Pedro Jaime Esteve), from whose surname originates the Latinized word stevia.

STV (commonly referred to as stevia sugar) and Reb A are glycosides with highly effective sweet taste properties. In fact, these compounds range in sweetness up to 380 times sweeter than sucrose. They are safe, non-toxic heat-stable, pH-stable, and do not ferment making them very commercially workable in the manufacture of foods and beverages. Furthermore, they do not induce a glycemic response when ingested (they have zero calories, zero carbohydrates and a zero glycemic index), making them extremely attractive as natural sweeteners to diabetics, those on carbohydrate-controlled diets and to anyone seeking healthy alternatives. The glycemic index, or GI, measures how fast a food will raise blood glucose level. Choosing foods that produce zero fluctuations in blood glucose is an important component for long-term health and reducing risk of heart disease and diabetes. As such, use of the natural sweetener compositions of the present invention has enormous advantages over cane, beet and other sugars.

In one embodiment, the sweetener composition of the invention comprises a blend of Reb A and STV extracts extracted from the leaves of Stevia rebaudiana. Surprisingly, the blend of Reb A and STV extracts provides a more preferred, better taste profile than a composition wherein Reb A extract or STV extract is the only steviol glycoside used in the natural sweetener composition. The ratio of Reb A extract to STV extract is preferably between about 12:1 and about 1:12. An even more preferred ratio for the ratio between Reb A extract and STV extract is between about 9:1 and about 1:9. A further preferred ratio for the ratio between Reb A extract and STV extract is between about 5:1 and about 1:5. Another preferred ratio for the ratio between Reb A extract and STV extract is between about 4:1 and about 1:4. Another preferred ratio for the ratio between Reb A extract and STV extract is between about 3:1 and about 1:3. Another preferred ratio for the ratio between Reb A extract and STV extract is between about 2:1 and about 1:2. The selection of the ratio of Reb A extract to STV extract is based on a comprehensive analysis of the taste profile, safety, production costs, and ease of use for the sweetener composition.

In a further alternative embodiment, the composition consists of Rebaudioside A (Reb A) and Stevioside (STV) extracts in a ratio between about 12:1 and about 1:12. An even more preferred ratio for the ratio between Reb A extract and STV extract is between about 9:1 and about 1:9. A further preferred ratio for the ratio between Reb A extract and STV extract is between about 5:1 and about 1:5. Another preferred ratio for the ratio between Reb A extract and STV extract is between about 4:1 and about 1:4. Another preferred ratio for the ratio between Reb A extract and STV extract is between about 3:1 and about 1:3. Another preferred ratio for the ratio between Reb A extract and STV extract is between about 2:1 and about 1:2.

In another alternative embodiment, the composition consists essentially of Rebaudioside A (Reb A) and Stevioside (STV) extracts in a ratio between about 12:1 and about 1:12. An even more preferred ratio for the ratio between Reb A extract and STV extract is between about 9:1 and about 1:9. A further preferred ratio for the ratio between Reb A extract and STV extract is between about 5:1 and about 1:5. Another preferred ratio for the ratio between Reb A extract and STV extract is between about 4:1 and about 1:4. Another preferred ratio for the ratio between Reb A extract and STV extract is between about 3:1 and about 1:3. Another preferred ratio for the ratio between Reb A extract and STV extract is between about 2:1 and about 1:2.

A sweetener composition comprising a blend of Reb A and STV extracts present in a specific ratio provides a more pleasing taste profile and sugar-like taste in comparison to compositions comprising only one of Reb A extract or STV extract. Without being bound by theory, it appears that the extracts of the Reb A and STV steviol glycosides have a synergistic relationship when the two are blended together in a specific ratio, such that the blend results in a taste profile that is more preferable to consumers than if either of the steviol glycoside extracts is used on its own.

During the extraction process, as increasing levels of purity of Reb A and STV extracts are produced, the costs associated with achieving such increasing levels of purity also increases. Those skilled in the art will understand that purifying steviol glycoside extracts, including Reb A and STV extracts, to higher levels of purity, especially purity levels greater than 95%, can be very costly, which can be limiting on the use of these steviol glycosides in sweetener compositions.

Surprisingly, a sweetener composition comprising a blend of Reb A and STV extracts, where the Reb A and STV extracts each have lower levels of purity, have a very similar or near equivalent taste profile as either Reb A extract and STV extract taken alone and extracted to a higher level of purity. The ability to produce sweetener compositions comprising a blend of lower purity STV and lower purity Reb A extracts facilitates lower production and manufacturing costs, a more streamlined extraction process, and an overall increase in the production of the sweetener composition. Extracts of varying purities can be used within the scope of the present invention. As such, another exemplary embodiment of the present invention is directed to Rebaudioside A and Stevioside having varying levels of purity. In one embodiment, the Reb A component has a purity between about 60% and about 97.5% content of Reb A present in the stevia extract, more preferably between about 70% and about 97.5%, even more preferably between 75% and about 95%, even more preferably between about 80% and about 95% and even more preferably between about 90% and about 95%. Even more preferably, the Reb A extract is about 95% pure.

In another embodiment, the STV component has a purity between about 60% and about 97.5% content of STV present in the stevia extract, more preferably between about 70% and about 97.5%, even more preferably between 75% and about 95%, even more preferably between about 80% and about 95% and even more preferably between about 90% and about 95%. Even more preferably, the STV extract is about 95% pure. In an alternative embodiment, the natural sweetener composition comprises one or more natural sugars and/or artificial sugars/or other sweet sugar substitutes (“secondary sweetening component”) in addition to Reb A and STV extracts. The ratio of the secondary sweetening component to Reb A and STV extracts will depend on the total level of sweetness that one is attempting to achieve. The ratio of secondary sweetening component to a blend comprising Reb A and STV extracts is preferably between about 1:1 and about 2000:1; more preferably between about 22.7:1 and 400:1; and even more preferably between about 10:1 to about 100:1.

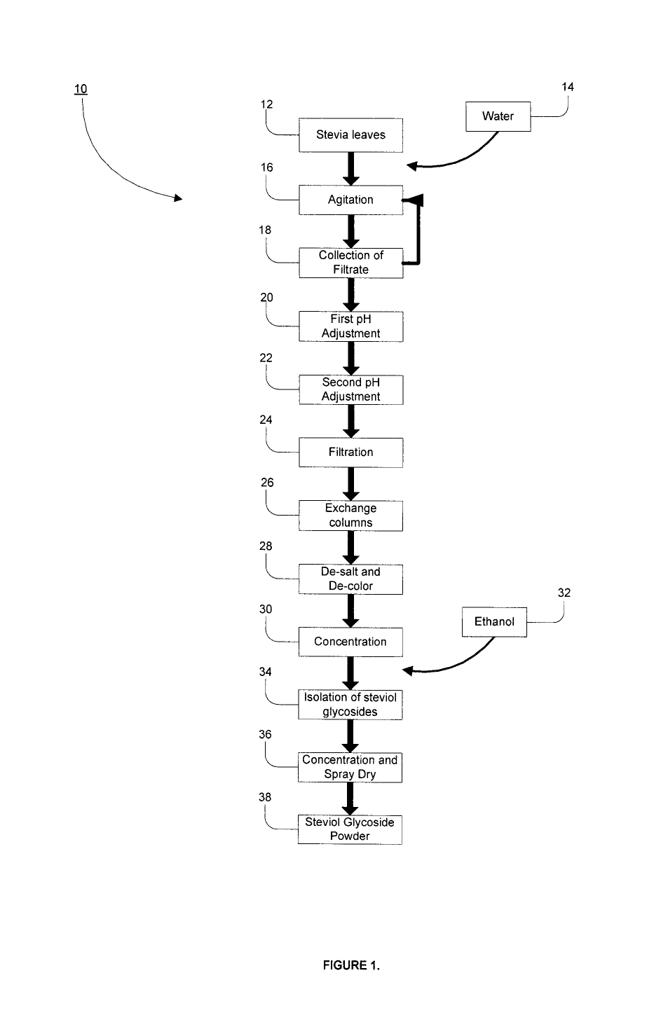

In an alternative embodiment, the ratio of secondary sweetening component to a blend comprising Reb A and STV extracts is preferably between about 5:1 and 1:1. The secondary sweetening component may be selected from the group consisting of sucrose, erythritol, fructose, glucose, maltose, lactose, corn syrup (preferably high fructose), xylitol, sorbitol, or other sugar alcohols, inulin, miraculin, monetin, thaumatin and combinations thereof, and also non-natural sweeteners such as aspartame, neotame, saccharin, sucralose and combinations thereof. Preferably, for a 50% reduced calorie table top product, the ratio of a secondary sweetening component (most preferably sucrose) to Reb A and STV is preferably about 24.7:1. Such a natural sweetener composition can easily be added to food products and beverages, or can be used as a table top sweetener. FIG. 1 shows an extraction process (10) used to isolate Reb A and STV extracts from Stevia leaves. As shown in FIG. 1, the Reb A and STV extracts are isolated using the following steps. The Stevia leaves (12) are dried and the dried stevia leaves are agitated (16) in a volume of water (14) to release the sweet glycosides from the dried stevia leaves. Preferably, the sweet glycosides are released from the dried leaves using between about 1 volume to about 15 volumes of water. Even more preferably, the sweet glycosides are released from the dried leaves using about 12 volumes of water. The water-leaves mixture is agitated (16) for a period of time between about 10 minutes and about 1 hour, more preferably for a period of time between about 25 minutes and about 35 minutes. Following the agitation (16), the water-leaves mixture is drained and the filtrate collected (18). The cycle of agitation (16) and the collection of filtrate (18) is repeated for a total of about five cycles. Over the course of the five cycles, the water-leaves mixture is agitated for a total period of time between about 1 hour and about 5 hours, more preferably for a total period of time between about 2 hours and about 3 hours.

In one embodiment, for each agitation/collection cycle, the water-leaves mixture is agitated (16) in an environment having a temperature between about 5° C. and about 50° C., more preferably at a temperature between about 20° C. and about 30° C. Following the completion of the agitation/collection cycles, the pH of the water-leaves mixture is first adjusted to about pH 8.0 (20). The pH adjusted water/leaves mixture is then allowed to stand for a period of time between about 30 minutes and about two hours. The pH of the water-leaves mixture is then adjusted a second time (22) to about pH 7.0. The water-leaves mixture is subsequently filtered (24) to obtain an aqueous filtrate. The aqueous filtrate is then applied to ion exchange columns (26) to purify and decontaminate the aqueous filtrate. A person skilled in the art would understand that other methods may also be used to purify and decontaminate the aqueous filtrate. The aqueous filtrate is subsequently de-salted and de-colorized (28) and concentrated (30) using adsorption resin beds. A person skilled in the art would understand that other methods may also be used to concentrate the aqueous filtrate. A filtrate solution containing concentrated steviol glycosides is released from the adsorption resin beds (34) by rinsing the adsorption resin beds with ethanol (32), preferably about 70% ethanol (32). The filtrate solution is further concentrated and spray-dried (36) to produce a steviol glycosides containing powder (38), where the steviol glycosides include Reb A and STV. The concentration of steviol glycosides in the powder (38) varies depending on the stevia leaves (12) used, for example the concentration of RebA may be between about 24.3% to about 57.6% and the concentration of STV may be between about 24.7% to about 59.6%.

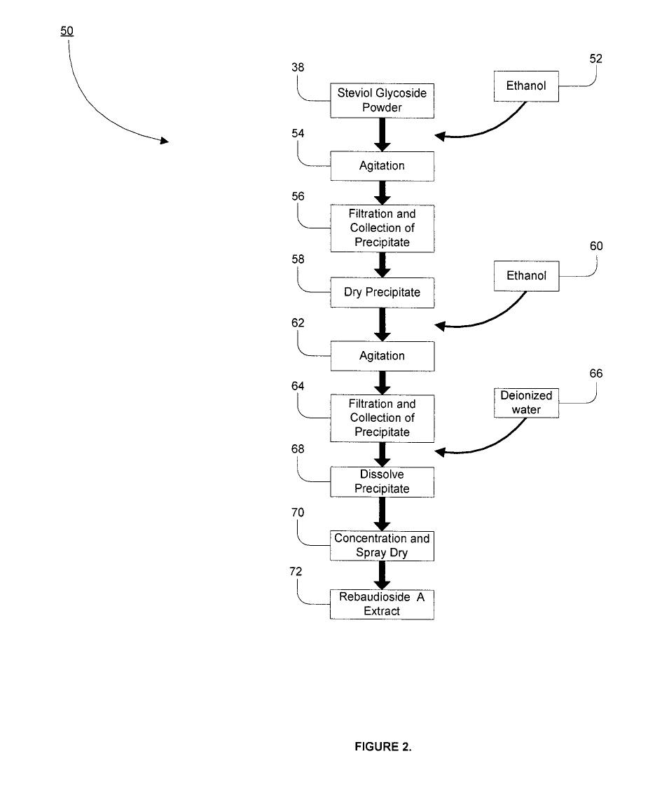

In one embodiment, Stevia leaves known to have a high content of Reb A are used to obtain a Reb A extract between about 60% and about 97.5% purity. Leaves known to have a high content of STV are used to obtain a STV extract between about 60% and about 97.5% purity. FIG. 2 illustrates a purification process (50) used to isolate Reb A extract from steviol glycoside powder (38) of FIG. 1. As shown in FIG. 2, Reb A extract is isolated using the following steps. Steviol glycoside powder (38), from the extraction process of FIG. 1, is mixed with ethanol (52), preferably between about 90% to about 95% ethanol, and the powder-ethanol mixture is agitated (54). The steviol glycoside powder (38) is mixed with preferably about two times volume (w/v) to about three times volume (w/v) of ethanol (52). Even more preferably, the steviol glycoside powder (38) is mixed with about two and a half times volume (w/v) of ethanol (52). The powder-ethanol mixture is agitated (54) for a period of time between about 30 minutes and about 2 hours, more preferably for a period of about one hour.

In one embodiment, the powder-ethanol mixture is agitated (54) in an environment having a temperature between about 25° C. and about 60° C., more preferably at a temperature between about 45° C. and about 50° C. The powder-ethanol mixture is subsequently filtered and the precipitate is collected (56). The precipitate is then dried (58). The precipitate is then mixed with ethanol (60). The ethanol (60) mixed with the precipitate is preferably between about 90% to about 95% ethanol, more preferably about 92% ethanol. Preferably, the precipitate is mixed with between about two times volume (w/v) to about four times volume (w/v) of ethanol (60). Even more preferably, the precipitate is mixed with three times volume (w/v) of ethanol 60. The precipitate-ethanol mixture is slowly agitated (62) for a period of time between about 45 minutes and about 1 hour, more preferably for a period of about 50 minutes.

In one embodiment, the precipitate-ethanol mixture is agitated (62) in an environment having a temperature between about 25° C. and about 60° C., more preferably at a temperature between about 45° C. and about 50° C. Following agitation (62) of the precipitate-ethanol mixture, the precipitate-ethanol mixture is filtered and the precipitate is collected (64). The precipitate comprises crystals of RebA, preferably crystals of higher purity Reb A, even more preferably crystals of about 95% Reb A content. The precipitate is subsequently dissolved (68) in deionized water (66). The solution is then concentrated and spray-dried (70) to produce a final Reb A extract (72).

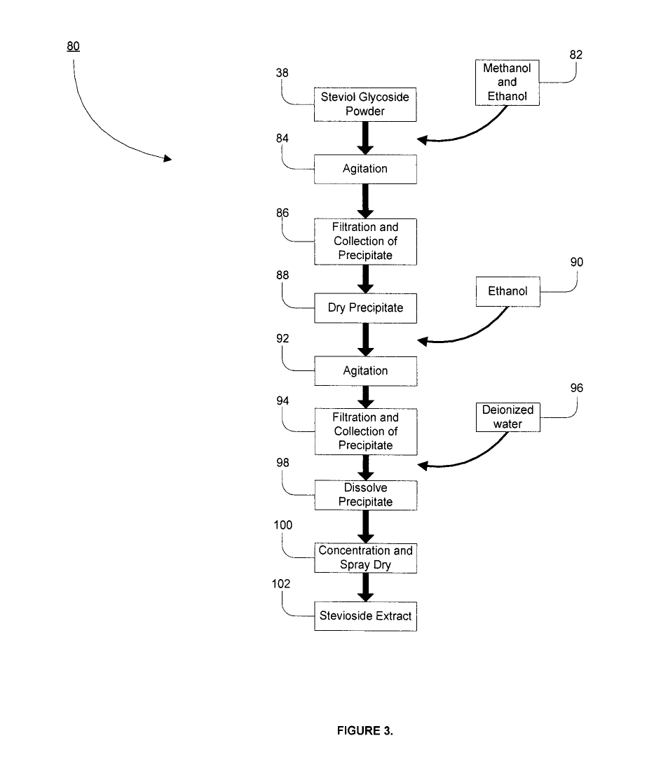

In one embodiment, the Reb A extract (72) is about 97.5% purity. A person skilled in the art would understand that other methods may also be used to dry the precipitate. FIG. 3 illustrates a purification process (80) used to isolate STV extract from the steviol glycoside powder (38) of FIG. 1. As shown in FIG. 3, STV extract is isolated using the following steps. Steviol glycoside powder (38) is mixed with a mixture of methanol and ethanol (82). The ratio of methanol to ethanol in the methanol-ethanol mixture (82) is preferably about 4:1. Preferably, the steviol glycoside powder (38) is mixed with between about two times volume (w/v) to about four times volume (w/v) of the methanol-ethanol mixture (82). Even more preferably, the steviol glycoside powder (38) is mixed with about three times volume (w/v) of the methanol-ethanol mixture (82). The powder-methanol-ethanol mixture is agitated (84) for a period of time between about 30 minutes and about 2 hours, more preferably for a period of about one hour.

In one embodiment, the powder-methanol-ethanol mixture is agitated (84) in an environment having a temperature between about 25° C. and about 60° C., more preferably at a temperature between about 45° C. and about 50° C. The powder-methanol-ethanol mixture is subsequently filtered and the precipitate is collected (86). The precipitate is the dried (88). The precipitate is then mixed with ethanol (90). The ethanol (90) that is mixed with the precipitate is preferably between about 87% to about 95% ethanol, more preferably about 90% ethanol. Preferably, the precipitate-ethanol mixture is mixed with about one and a half times volume (w/v) to about two and half times volume (w/v) of ethanol (90). Even more preferably, the precipitate-ethanol mixture is mixed with two times volume (w/v) of ethanol (90). The precipitate-ethanol mixture is slowly agitated (92) for a period of time between about 45 minutes and about 1 hour, more preferably for a period of about 50 minutes.

In one embodiment, the precipitate-ethanol mixture is agitated (92) in an environment having a temperature between about 25° C. and about 60° C., more preferably at a temperature between about 45° C. and about 50° C. Following agitation (92) of the precipitate-ethanol mixture, the precipitate-ethanol mixture is filtered and the precipitate is collected (94). The precipitate comprises crystals of STV, preferably crystals of higher purity STV, even more preferably crystals of about 95% STV content. The precipitate is subsequently dissolved (98) in deionized water (96). The solution is then concentrated and spray-dried (100) to produce a final STV extract (102).

In one embodiment, the STV extract (102) is about 97.5% purity. A person skilled in the art would understand that other methods may also be used to dry the precipitate. Following the extraction process (10) shown in FIG. 1 and purification of Reb A extract (72) and STV extract (102), the Reb A extract (72) and STV extract (102) are blended for use in natural sweetener compositions. The sweetener compositions described above are: (a) low calorie or reduced calorie; (b) made from all natural products; (c) have a favourable safety profile; (d) demonstrate good thermal stability during processing; and (e) are less fermentable by oral dental-caries causative microorganisms than sugar.

The sweetener compositions of the present invention may be used in the preparation of various food products, beverages, medicinal formulations, chemical industrial products, among others. Exemplary applications/uses for the sweetener compositions include, but are not limited to: (a) food products, including canned food, preserved fruits, pre-prepared foods, soups, (b) beverages, including coffee, cocoa, juice, carbonated drinks, sour milk beverages, yogurt beverages, meal replacement beverages, and alcoholic drinks, such as brandy, whisky, vodka and wine; (c) grain-based goods—for example, bread and pastas, cookies, pastries, whether these goods are cooked, baked or otherwise processed; (d) fat-based products—such as margarines, spreads (dairy and non-dairy), peanut butter, peanut spreads, and mayonnaise; (d) Confectioneries—such as chocolate, candies, toffee, chewing gum, desserts, non-dairy toppings (for example Cool Whip®), sorbets, dairy and non-dairy shakes, icings and other fillings, (e) drug and medicinal formulations, particularly in coatings and flavourings; (f) cosmetics and health applications, such as for sweetening toothpaste; and (g) seasonings for various food products, such as soy sauce, soy sauce powder, soy paste, soy paste powder, catsup, marinade, steak sauce, dressings, mayonnaise, vinegar, powdered vinegar, frozen-desserts, meat products, fish-meat products, potato salad, bottled and canned foods, fruit and vegetables.

The natural sweetener compositions of the present invention may be formulated into premixes and sachets. Such premixes may then be added to a wide variety of foods, beverages and nutraceuticals. The purified natural sweetener compositions may, in one preferred form, be table top sweeteners.

The natural sweetener compositions may be used alone or in combination with other secondary sweeteners, as described herein, and/or with one or more organic and amino acids, flavours and/or coloring agents. Different products employ sweetener compositions having specific ratios of Reb A extract to STV extract. These ratios are selected to achieve a high product quality, taste and flavour. Exemplary ratios of the Reb A and STV extracts are listed in the table below for use in various products as described in the following examples.

| Application | Reb A Extract | STV Extract |
|---|---|---|
| Beverages | | |
| Lemon drink | 1.5 | 1 |
| Orange beverage | 2.4 | 1 |
| Carbonated drink | 4.5 | 1 |
| Hot Chocolate | 1.5 | 1 |
| Other soft drinks and still beverages | 3.2 | 1 |
| Confectionaries | | |
| Peppermint candy | 1.5 | 1 |
| Table Top | | |
| Low calorie | 4.5 | 1 |
| Reduced calorie | 10.9 | 1 |
| Food Products | | |
| Vanilla cookie | 2.5 | 1 |
| Brioche bread | 2.4 | 1 |

The means by which the sweetener compositions having specific ratios of Reb A extract to STV extract will be added to, or incorporated in or on the food, beverage or other product will depend largely on the specific type of product. It is anticipated that such incorporation will occur at the time of manufacture of the food product, although in many cases, later addition may also be possible.

While the forms of composition, method and process described herein constitute preferred embodiments of this invention, it is to be understood that the invention is not limited to these precise forms. As will be apparent to those skilled in the art, the various embodiments described above can be combined to provide further embodiments. Aspects of the present composition, method and process (including specific components thereof) can be modified, if necessary, to best employ the systems, methods, nodes and components and concepts of the invention. These aspects are considered fully within the scope of the invention as claimed. For example, the various methods described above may omit some acts, include other acts, and/or execute acts in a different order than set out in the illustrated embodiments.

Further, in the methods taught herein, the various acts may be performed in a different order than that illustrated and described. Additionally, the methods can omit some acts, and/or employ additional acts.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

The following examples illustrate preferred embodiments of the present invention.

### EXAMPLES

### Example 1

### Extraction of Steviol Glycosides from Stevia rebaudiana Leaves

One kg of the stevia leaves known to have a high content of Rebaudioside A were steeped with 2 kg of room temperature water having a pH of 7.3 in an agitation centrifuge. The leaves were agitated for 0.5 hour. The sweet water was filtered, the filtrate collected and the process repeated for a total of 5 steep/separation cycles. The pH of the sweet water filtrate solution was adjusted to pH 8.0 with approximately 30 grams of calcium hydroxide. After a rest time of about 1 hour, 50 grams of FeCl₃ was added to the sweet water filtrate solution to further adjust the pH to 7.0. The solution was filtered and the resulting filtrate had a transmittance of about 68±2% at 325 nm.

The sweet water solution was then subjected to ion exchange columns consisting of both anion resin and cation resins, and then adsorption resin beds to de-salt, de-color and concentrate the sweet water. Subsequently, the resin beds were rinsed with ethanol (70%) to isolate the steviol glycosides from the resin beds. A sweet water solution with at least 96% transmittance at 325 nm was concentrated and spray dried. The yield was 130 grams of powder with a content of steviol glycosides of about 88.2%. The powder contained 57.6% Rebaudioside A content and 24.7% Stevioside content.

Following a similar process to that outlined about, stevia leaves known to have a high content of Stevioside yield a powder of 130 grams of powder with a content of steviol glycosides of about 89.0% was obtained. The mixture contained 24.3% Rebaudioside A content and 59.6% Stevioside content.

### Example 2

### Preparation of Rebaudioside A Extract

The powder containing 57.6% Rebaudioside A (RebA) content isolated by the process of EXAMPLE 1 was mixed with 2.5 times volume (w/v) of 92.0% ethanol at a temperature between about 45-50° C. for 1 hour with slow agitation. The RebA solution was filtered and a precipitate containing Rebaudioside A was dried to a powder. The resulting RebA powder had 89.2% RebA content. The powder was then mixed with three volumes (w/v) of 92% of ethanol, and maintained at a temperature of 45-50° C. for about 50 minutes with slow agitation. The precipitate was separated from the solution by filtration and the resulting precipitate comprised crystals of about 95.0% RebA content. The crystals were dissolved at room temperature in deionized water. The solution was concentrated and spray dried. The final RebA extract had a purity of about 97.5%.

### Example 3

### Preparation of Stevioside Extract

The powder containing 59.6% Stevioside (STV) content isolated by the process of EXAMPLE 1 was mixed with 3 times volume (w/v) of mixture of methanol and ethanol having a methanol:ethanol ratio of 4:1. The STV solution was mixed at a temperature of 45-50° C. for 1 hour with slow agitation. The STV solution was filtered and a precipitate containing Stevioside was dried to a powder. The resulting STV powder had 85% STV content. The powder was then mixed with 2 volumes (w/v) of 90% of ethanol, and maintained at a temperature of 45-50° C. for about 50 minutes with slow agitation. The precipitate was separated from the solution by filtration and the resulting precipitate comprised crystals of about 96.2% STV content. The crystals were dissolved at room temperature in deionized water. The solution was concentrated and spray dried. The final STV extract had a purity of about 97.5%.

### Example 4

### Taste Analysis of Reb A:STV Blends as Compared to Sucrose

The extracts of Reb A and STV were prepared using the processes of Examples 1-3.

| Implemen- | Blending | Sweetness | | Level of Purity | |
|---|---|---|---|---|---|
| tation cases | Ratio | multiple | Taste | Reb A | STV |
| 1 | RA:STV = | 338 | mellow | 97.5 | 97.5 |
| | 9:2 | | cool | | |
| 2 | RA:STV = | 326 | mellow | 97.5 | 97.5 |
| | 4:1 | | cool | | |
| 3 | RA:STV = | 318 | mellow | 97.5 | 97.5 |
| | 8:3 | | cool | | |
| 4 | RA:STV = | 305 | mellow | 97.5 | 97.5 |
| | 7:2 | | cool | | |

Notes:
1. The sweetness of the table is based on the same amount of sucrose.
2. A sweetness panel, n = 5, was used to assess sweetness levels and taste.
3. A 10% sucrose solution was set as a standard

### Example 5

### Taste Analysis of Natural Sweetener Comprising a Blend of Sucrose, Reb A and STV

The extracts of Reb A and STV were prepared using the processes of Examples 1-3.

| Implemen- | Blending | Sweetness | | Level of Purity | |
|---|---|---|---|---|---|
| tation cases | Ratio | multiple | Taste | Reb A | STV |
| 1 | (Reb A & | 140 | mellow | 95 | 95 |
| | STV):Sucrose = | | cool | | |
| | 1:1.02 | | | | |
| 2 | (Reb A & | 112 | mellow | 95 | 95 |
| | STV):Sucrose = | | cool | | |
| | 1:1.47 | | | | |
| 3 | (Reb A & | 98 | mellow | 95 | 95 |
| | STV):Sucrose = | | cool | | |
| | 1:1.82 | | | | |
| 4 | (Reb A & | 81 | mellow | 95 | 95 |
| | STV):Sucrose = | | cool | | |
| | 1:2.5 | | | | |

Notes:
1. The sweetness of the table is based on the same amount of sucrose.
2. A sweetness panel, n = 5, was used to assess sweetness levels and taste.
3. A 10% sucrose solution was set as a standard

### Example 6

### Zero-Calorie Natural Lemon Drink

Fresh-squeezed lemon juice (10%), ascorbic acid (0.03%), sodium benzoate (0.02%), and sweetener extract (0.04%) containing a ratio of 57% Rebaudioside A extract (95% purity) to 38% Stevioside extract (95% purity) was blended and dissolved in carbon filtered water to 100%. The resulting product was a fresh tasting lemonade beverage with a very acceptable taste and sweetener profile.

Other fruit beverages may be prepared in a similar manner by substituting the lemon juice with other fruit juices, such as orange, pineapple, grape, cherry, mango, guava, blueberry, etc.

### Example 7

### Low-Calorie Orange-Flavored Beverage

Orange juice concentrate (20%), sucrose (5%), citric acid (0.2%), sweetener (0.22%) comprising a blend of 67% Rebaudioside A extract (95% purity) and 28% Stevioside extract (95% purity) was blended and dissolved in carbon filtered water to 100%. The resulting product had appealing flavor, mouth feel, and sweetness levels. The calorie reduction was approximately 40%.

### Example 8

### Zero-Calorie Carbonated Drink

A cola concentrate (1.5%) containing phosphoric acid, sodium benzoate, caramel color, sweetener (0.05%) comprising a blend of 77% Rebaudioside A extract (95% purity) and 17% Stevioside extract (95% purity) was blended and dissolved in carbon filtered carbonated water to 100%. The finished product was a refreshing and appropriately sweet-tasting carbonated cola drink without any lingering aftertaste.

### Example 9

### Reduced-Calorie Carbonated Drink

A cola concentrate (1.5%) containing phosphoric acid, sodium benzoate, caramel color, sucrose (5.5%), sweetener (0.022%) comprising a blend of 77% Rebaudioside A extract (95% purity) and 17% Stevioside extract (95% purity) was blended and dissolved in carbon filtered carbonated water to 100%. The finished product was a refreshing and appropriately sweet-tasting carbonated cola drink with good mouth feel and without any lingering aftertaste.

### Example 10

### Organoleptic Taste Test

A side-by-side taste organoleptic taste test was conducted with 15 panelists in a product matrix containing sweetener (0.04%) concentrations containing either 100% Rebaudioside A extract (97% purity) or a blend of 73% Rebaudioside A extract (95% purity) and 23% Stevioside extract (95% purity), and 0.25% citric acid in carbon filtered water to 100%. The tasters compared both sweeteners and there was very little distinction between the pure Rebaudioside A extract formulation at 97% purity and the blended formulation with both Rebaudioside A extract and Stevioside extract at 95% purity. The blended formulation comprised of Rebaudioside A and Stevioside extracts at the lower purity of 95% was less expensive to produce with the same effect on taste profile, as compared to the 97% purity Rebaudioside A extract used alone.

### Example 11

### Hot-Chocolate Drink

Unsweetened chocolate (15%), sweetener (0.04%) comprising a blend of 57% Rebaudioside A extract (95% purity) and 37% Stevioside extract (95% purity), and whole milk to 100% is combined and slowly heated until all the chocolate is melted and dissolved into a homogeneous solution. The final product has a very pleasant taste, mouth feel, and no lingering after taste.

Many extensions can be made on Example 11, such as chilling the mixture for a chocolate milk product, adding coffee for a latte product, and adding vanilla, cinnamon, cardamom, or other spices for further variations on the chocolate drink theme.

### Example 12

### Low-Calorie Vanilla Cookie

Ingredients: Butter (27%), sucrose (6.3%), polydextrose (9%), sweetener (0.03%) comprising a blend of 67% Rebaudioside A extract (95% purity) and 27% Stevioside extract (95% purity), sifted all-purpose flour (57%), vanilla (0.5%), and salt (0.25%).

Method: Cream the butter with the sugar and Stevia glycoside blend. Once lightened, add the flour slowly until completely incorporated. Shape the dough into a disk and freeze for 20 minutes. Remove from freezer, roll dough to ¼ inch thick, cut into rounds, and bake in a 350□F oven for 12-14 minutes or until done.

The final product is a low calorie cookie that is flavorful, sweet, and texturally satisfying.

Many variations can be applied to Example 12, such as adding lemon zest, orange zest, chocolate chips, almonds and/or other nuts, etc.

### Example 13

### Reduced Calorie Peppermint Candy

Ingredients: sucrose (27%), sweetener (0.1%) comprising a blend of 57% Rebaudioside A extract (95% purity) and 37% Stevioside extract (95% purity), light corn syrup (20%), peppermint extract (0.25%), and red food coloring (0.01%).

Method: The sugar, sweetener, and corn syrup are combined in a heavy saucepan and heated until all the ingredients dissolve and until the mixture has reached the hard crack stage (300□F).

After the sugar mixture has reached the hard crack stage, the flavor extract and coloring is added and stirred to combine; the hot mixture is then poured onto a pan and cooled until the candy can be cut and molded into desired shapes and sizes.

The product is a low-calorie hard candy with a very desirable flavor profile Example 13 may be modified to include a variety of different flavor profiles including butterscotch, cinnamon, lemon, etc.

### Example 14

### Low-Calorie Table Top Product

35 mg of a sweetener blend comprising 77% Rebaudioside A extract (95% purity) and 17% Stevioside extract (95% purity) is combined with one or more of a variety of bulk agents, including maltodextrin, erythritol, sorbitol, or other cellulosic material to produce a sweet sugar substitute for use as a table top sugar replacement.

### Example 15

### Low-Calorie Table Top Blend Sugar Product

The sweetener blend in Example 14 was paired with 1 to 5 grams of sugar to produce a sugar/stevia glycoside sweetener product suitable for table top packaging and applications

### Example 16

### Reduced-Calorie Table Top Product

17 mg of a sweetener comprising 87% Rebaudioside A extract (95% purity) and 8% Stevioside extract (95% purity) was combined with 4.2 grams of sucrose to produce a 50% reduced calorie sweetener table top product. The product flows, performs, and tastes very similar to a 100% sucrose sugar sachet.

### Example 17

### Reduced Calorie Brioche Bread

30 grams of water, 12.5 grams of sucrose, 0.8 grams of instant yeast, 70 grams of all-purpose flour, and one egg was mixed together and left to rise overnight. The resultant sponge was added to 162 grams of all purpose flour, 12 grams of sucrose, 50 mg of a sweetener comprising a blend of 67% Rebaudioside A extract (95% purity) and 28% Stevioside extract (95% purity), 4 grams of instant yeast, 3 grams of salt, two large eggs (110 grams), and 110 grams of butter. This dough was kneaded for 10 minutes and was left to rise for two hours. After the first rise, the dough was kneaded again for three minutes and let to rise again for 2 hours. The dough was then shaped and placed in a 425□F oven for 40 minutes. The final product was a rich buttery sweet brioche bread with good structure and texture.

### Example 18

### Sweetness Comparison

Sweetening composition comprising 75% of Reb A95 and 25% of STV95 was assessed for sweetness and compared to 100% RebA97 with results showing sweetness being very close. Sweetness test is based upon comparing a 5% sugar and water solution to test composition (STV-RebA) and water solution.

The above-described embodiments have been provided as examples, for clarity in understanding the invention. A person of skill in the art will recognize that alterations, modifications and variations may be effected to the embodiments described above while remaining within the scope of the invention as defined by the claims appended hereto.

1. A natural sweetener composition comprising a blend of Stevioside extract and Rebaudioside A extract wherein the ratio of Rebaudioside A extract to Stevioside extract is between about 12:1 to about 1:12.

2. The natural sweetener composition of claim 1, wherein the natural sweetener is zero calories.

3. The natural sweetener composition of claim 1 wherein the natural sweetener is reduced calorie.

4. The natural sweetener composition of claim 1, wherein the ratio of Rebaudioside A extract to Stevioside extract is between about 9:1 and about 1:9.

5. The natural sweetener composition of claim 1, wherein the ratio of Rebaudioside A extract to Stevioside extract is between about 8:1 and about 1:8.

6. The natural sweetener composition of claim 1, wherein the ratio of Rebaudioside A extract to Stevioside extract is between about 7:1 and about 1:7.

7. The natural sweetener composition of claim 1, wherein the ratio of Rebaudioside A extract to Stevioside extract is between about 6:1 and about 1:6.

8. The natural sweetener composition of claim 1, wherein the ratio of Rebaudioside A extract to Stevioside extract is between about 5:1 and about 1:5.

9. The natural sweetener composition of claim 1, wherein the ratio of Rebaudioside A extract to Stevioside extract is between about 4:1 and about 1:4.

10. The natural sweetener composition of claim 1, wherein the ratio of Rebaudioside A extract to Stevioside extract is between about 3:1 and about 1:3.

11. The natural sweetener composition of claim 1, wherein the ratio of Rebaudioside A extract to Stevioside extract is between about 2:1 and about 1:2.

12. The natural sweetener composition of claim 1, wherein the ratio of Rebaudioside A extract to Stevioside extract is between about 12:1 and about 2:1.

13. The natural sweetener composition of claim 1, wherein the ratio of Rebaudioside A extract to Stevioside extract is between about 9:1 and about 2:1.

14. The natural sweetener composition of claim 1, wherein the ratio of Rebaudioside A extract to Stevioside extract is between about 8:1 and about 2:1.

15. The natural sweetener composition of claim 1, wherein the ratio of Rebaudioside A extract to Stevioside extract is between about 7:1 and about 2:1.

16. The natural sweetener composition of claim 1, wherein the ratio of Rebaudioside A extract to Stevioside extract is between about 6:1 and about 2:1.

17. The natural sweetener composition of claim 1, wherein the ratio of Rebaudioside A extract to Stevioside extract is between about 5:1 and about 2:1.

18. The natural sweetener composition of claim 1, wherein the ratio of Rebaudioside A extract to Stevioside extract is between about 4:1 and about 2:1.

19. The natural sweetener composition of claim 1, wherein the ratio of Rebaudioside A extract to Stevioside extract is between about 3:1 and about 2:1.

20. The natural sweetener composition of claim 1, wherein the Rebaudioside A extract is between about 60% to about 97.5% purity.

21. The natural sweetener composition of claim 1, wherein the Rebaudioside A extract is between about 70% to about 97.5% purity.

22. The natural sweetener composition of claim 1, wherein the Rebaudioside A extract is between about 80% to about 97.5% purity.

23. The natural sweetener composition of claim 1, wherein the Rebaudioside A extract is between about 90% to about 97.5% purity.

24. The natural sweetener composition of claim 1, wherein the Rebaudioside A extract is about 95% purity.

25. The natural sweetener composition of claim 1, wherein the Stevioside extract is about 60% to about 97.5% purity.

26. The natural sweetener composition of claim 1, wherein the Stevioside extract is about 70% to about 97.5% purity.

27. The natural sweetener composition of claim 1, wherein the Stevioside extract is about 80% to about 97.5% purity.

28. The natural sweetener composition of claim 1, wherein the Stevioside extract is about 90% to about 97.5% purity.

29. The natural sweetener composition of claim 1, wherein the Stevioside extract is about 95% purity.

30. The natural sweetener composition of claim 1 further comprising at least one secondary sweetener selected from the group consisting of sucrose, erythritol, fructose, glucose, maltose, lactose, corn syrup, xylitol, sorbitol, or other sugar alcohols, inulin, miraculin, monetin, thaumatin, aspartame, neotame, saccharin, sucralose and combinations thereof.

31. The natural sweetener composition of claim 30, where the sweet sugar is sucrose.

32. The natural sweetener composition of claim 30, wherein the natural sweetener is reduced calorie.

33. The natural sweetener composition of claim 31, wherein the ratio of sucrose to the blended Rebaudioside A extract and Stevioside extract is between about 400:1 to about 1:1.

34. The natural sweetener composition of claim 31, further comprising sucrose wherein the ratio of sucrose to the blended Rebaudioside A extract and Stevioside extract is between about 300:1 to about 1:1.

35. The natural sweetener composition of claim 31, further comprising sucrose wherein the ratio of sucrose to the blended Rebaudioside A extract and Stevioside extract is between about 300:1 to about 20:1.

36. The natural sweetener composition of claim 31, wherein the percentage of sucrose in the is between about 1% and about 60%.

37. The natural sweetener composition of claim 31, wherein the Rebaudioside A extract is between about 60% to about 97.5% purity.

38. The natural sweetener composition of claim 31, wherein the Rebaudioside A extract is between about 70% to about 97.5% purity.

39. The natural sweetener composition of claim 31, wherein the Rebaudioside A extract is between about 80% to about 97.5% purity.

40. The natural sweetener composition of claim 31, wherein the Rebaudioside A extract is between about 90% to about 97.5% purity.

41. The natural sweetener composition of claim 31, wherein the Rebaudioside A extract is about 95% purity.

42. The natural sweetener composition of claim 31, wherein the Stevioside extract is about 60% to about 97.5% purity.

43. The natural sweetener composition of claim 31, wherein the Stevioside extract is about 70% to about 97.5% purity.

44. The natural sweetener composition of claim 31, wherein the Stevioside extract is about 80% to about 97.5% purity.

45. The natural sweetener composition of claim 31, wherein the Stevioside extract is about 90% to about 97.5% purity.

46. The natural sweetener composition of claim 31, wherein the Stevioside extract is about 95% purity.

47. The natural sweetener composition of claim 1 further comprising a non-natural sweetener selected from the group comprising aspartame, neotame, saccharin, sucralose and combinations thereof.

48. The natural sweetener composition of claim 47, wherein the natural sweetener is reduced calorie.

49. The natural sweetener composition of claim 47, wherein the Rebaudioside A extract is between about 60% to about 97.5% purity.

50. The natural sweetener composition of claim 47, wherein the Rebaudioside A extract is between about 70% to about 97.5% purity.

51. The natural sweetener composition of claim 47, wherein the Rebaudioside A extract is between about 80% to about 97.5% purity.

52. The natural sweetener composition of claim 47, wherein the Rebaudioside A extract is between about 90% to about 97.5% purity.

53. The natural sweetener composition of claim 47, wherein the Rebaudioside A extract is about 95% purity.

54. The natural sweetener composition of claim 47, wherein the Stevioside extract is about 60% to about 97.5% purity.

55. The natural sweetener composition of claim 47, wherein the Stevioside extract is about 70% to about 97.5% purity.

56. The natural sweetener composition of claim 47, wherein the Stevioside extract is about 80% to about 97.5% purity.

57. The natural sweetener composition of claim 47, wherein the Stevioside extract is about 90% to about 97.5% purity.

58. The natural sweetener composition of claim 47, wherein the Stevioside extract is about 95% purity.

59. A process for producing the natural sweetener composition of claim 1 comprising Stevioside extract and Rebaudioside A extract, said process comprising the steps of:
a) drying Stevia leaves;
b) mixing and agitating the dried Stevia leaves with water to produce a water-leaves mixture;
c) filtering the water-leaves mixture to obtain an aqueous filtrate; and
d) subjecting the aqueous filtrate to ion exchange columns and adsorption resin beds to isolate a steviol glycoside extract;
e) isolating a Stevioside extract from the steviol glycoside extract;
f) isolating a Rebaudioside A extract from the steviol glycoside extract; and
g) blending the Rebaudioside A extract with the Stevioside extract to produce the sweetener composition.

60. The process of claim 59, wherein the mixture and agitation of the dried Stevia leaves with water is conducted with about 1 volume of water to about 15 volumes of water.

61. The process of claim 59, wherein the mixture and agitation of the dried Stevia leaves with water is conducted for about one hour to about five hours at about 5° C. to about 50° C.

62. The process of claim 59, wherein the water-leaves mixture is filtered to obtain an aqueous filtrate at room temperature using a compress filter for about three hours.

63. The process of claim 59, wherein the steviol glycoside extract is crystallized with an ethanol and methanol solvent to isolate and purify a Stevioside extract.

64. The process of claim 59 wherein, the steviol glycoside extract is crystallized with ethanol to isolate and purify Rebaudioside A extract.

65. A method of enhancing sweetness in foods, beverages, nutraceuticals, medicinal formulations, cosmetics, health products, condiments and seasonings which comprises adding to said foods, beverages, nutraceuticals, medicinal formulations, cosmetics, health products, condiments and seasonings a natural sweetener composition comprising comprising a blend of Stevioside extract and Rebaudioside A extract wherein the ratio of Rebaudioside A extract to Stevioside extract is between about 12:1 to about 1:12.

66. The method of claim 65 wherein the natural sweetener composition additionally comprises at least one secondary sweetener selected from the group consisting of sucrose, erythritol, fructose, glucose, maltose, lactose, corn syrup, xylitol, sorbitol, or other sugar alcohols, inulin, miraculin, monetin, thaumatin, aspartame, neotame, saccharin, sucralose and combinations thereof.

67. A food product comprising a natural sweetener composition comprising comprising a blend of Stevioside extract and Rebaudioside A extract wherein the ratio of Rebaudioside A extract to Stevioside extract is between about 12:1 to about 1:12.

68. A beverage comprising a natural sweetener composition comprising a blend of Stevioside extract and Rebaudioside A extract wherein the ratio of Rebaudioside A extract to Stevioside extract is between about 12:1 to about 1:12.

69. A table-top sweetener sachet comprising a natural sweetener composition comprising comprising a blend of Stevioside extract and Rebaudioside A extract wherein the ratio of Rebaudioside A extract to Stevioside extract is between about 12:1 to about 1:12.

70. The sachet of claim 69 wherein the natural sweetener composition additionally comprises at least one secondary sweetener selected from the group consisting of sucrose, erythritol, fructose, glucose, maltose, lactose, corn syrup, xylitol, sorbitol, or other sugar alcohols, inulin, miraculin, monetin, thaumatin, aspartame, neotame, saccharin, sucralose and combinations thereof.

71. The sachet of claim 69 wherein the natural sweetener composition additionally comprises sucrose.

72. The sachet of claim 69 wherein the purity of both the Rebaudioside A extract and Stevioside extract is between about 60% to about 97.5%.
